(19) United States
(12) Patent Application Publication
(10) Pub. No.: US 2023/0021454 A1
(43) Pub. Date: Jan. 26, 2023

(54) SYSTEMS AND METHODS OF PREAMBLES FOR UWB TRANSMISSION

(71) Applicant: Meta Platforms Technologies, LLC, Menlo Park, CA (US)

(72) Inventors: Carlos Horacio Aldana, Mountain View, CA (US); Qiyue Zou, Elk Grove, CA (US)

(21) Appl. No.: 17/841,198

(22) Filed: Jun. 15, 2022

Related U.S. Application Data
(60) Provisional application No. 63/222,207, filed on Jul. 15, 2021.

(51) Int. Cl. H04B 1/7163; H04B 1/719

(52) U.S. Cl. CPC H04B 1/71632; H04B 1/719

(57) ABSTRACT

Systems and methods for selecting preamble codes for ultra-wideband (UWB) data transmissions include a device which selects a first preamble code of a plurality of preamble codes for a data transmission sent via at least one UWB antenna to a second device. Each of the plurality of preamble codes may have a sidelobe suppression ratio of at least 12 dB with respect to another one of the plurality of preamble codes. The device may transmit the data transmission including the first preamble code via the UWB antenna to the second device.

### CROSS-REFERENCE TO RELATED APPLICATION(S)

This application claims the benefit of and priority to U.S. Provisional Application No. 63/222,207, filed Jul. 15, 2021, the contents of which are incorporated herein by reference in its entirety.

### BACKGROUND

Artificial reality such as virtual reality (VR), augmented reality (AR), or mixed reality (MR) provides immersive experience to a user. Typically, in systems and methods which implement or otherwise provide immersive experiences, such systems utilize Wi-Fi, Bluetooth, or Radio wireless links to transmit/receive data. However, using such wireless links typically requires detailed coordination between links, particularly where multiple devices in the same environment are utilizing the same wireless link technology for communications.

### SUMMARY

In one aspect, this disclosure is directed to a method. The method may include selecting, by a first device, a first preamble code of a plurality of preamble codes for a data transmission sent via at least one ultra-wideband (UWB) antenna to a second device. Each of the plurality of preamble codes may have a sidelobe suppression ratio of at least 12 dB with respect to another one of the plurality of preamble codes. The method may include transmitting, by the first device, the data transmission including the first preamble code via the UWB antenna to the second device.

In some embodiments, the method includes determining, by the first device, that a third device in an environment of the first device and second device is using the first preamble code. The method may include selecting, by the first device, a second preamble code of the plurality of preamble codes, for a subsequent data transmission. In some embodiments, all of the plurality of preamble codes have a same sequence length. In some embodiments, a second plurality of preamble codes having the same sequence length is defined. Each of the second plurality of preamble codes may be (i) distinct from the plurality of preamble codes and (ii) having a sidelobe suppression ratio of at least 12 dB with respect to another one of the second plurality of preamble codes. In some embodiments, the plurality of preamble codes include an alphabet of at least one of two characters or four characters. In some embodiments, the two characters or four characters include one or more characters from {0, 1, −1, i, −i}.

In some embodiments, the plurality of preamble codes comprises m-sequence preamble codes. In some embodiments, the plurality of preamble codes include preamble codes having a sequence length of 15, 17, 19, 63, 255, 511, 1023, or 2047. In some embodiments, the method includes determining, by the first device, that a third device in an environment of the first device and the second device is using a preamble code of the plurality of preamble codes. The method may include identifying, by the first device, a second plurality of preamble codes. The method may further include selecting, by the first device, a second preamble code of the second plurality of preamble codes for a subsequent data transmission. In some embodiments, the plurality of preamble codes has a same number of preamble codes as the second plurality of preamble codes.

In another aspect, this disclosure is directed to a first device. The first device may include at least one ultra-wideband (UWB) antennas. The first device may include at least one processor configured to select a first preamble code of a plurality of preamble codes for a data transmission sent via at least one ultra-wideband (UWB) antenna to a second device. Each of the plurality of preamble codes may have a sidelobe suppression ratio of at least 12 dB with respect to another one of the plurality of preamble codes. The processor may be configured to transmit, via the at least one UWB antenna, the data transmission including the first preamble code via the UWB antenna to the second device.

In some embodiments, the at least one processor is configured to determine that a third device in an environment of the first device and second device, is using the first preamble code. The at least one processor may be configured to select a second preamble code of the plurality of preamble codes, for a subsequent data transmission. In some embodiments, all of the plurality of preamble codes have a same sequence length. In some embodiments, a second plurality of preamble codes having the same sequence length is defined. Each of the second plurality of preamble codes may be (i) distinct from the plurality of preamble codes and (ii) having a sidelobe suppression ratio of at least 12 dB with respect to another one of the second plurality of preamble codes. In some embodiments, the plurality of preamble codes includes an alphabet of at least one of two characters or four characters. In some embodiments, the two characters or four characters include one or more characters from {0, 1, −1, i, −i} (e.g., possible candidate characters, and can also include any such character multiplied/divided by a respective factor/value).

In some embodiments, the plurality of preamble codes comprises m-sequence preamble codes. In some embodiments, the plurality of preamble codes includes preamble codes having a sequence length of 15, 17, 19, 63, 255, 511, 1023, or 2047. In some embodiments, the at least one processor is configured to determine that a third device in an environment of the first device and the second device is using a preamble code of the plurality of preamble codes. The at least one processor may be configured to identify a second plurality of preamble codes. The at least one processor may be configured to select a second preamble code of the second plurality of preamble codes for a subsequent data transmission. In some embodiments, the plurality of preamble codes has a same number of preamble codes as the second plurality of preamble codes.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of an artificial reality environment, according to an example implementation of the present disclosure.

FIG. 4 is a block diagram of another artificial reality environment, according to an example implementation of the present disclosure.

FIG. 5 is a block diagram of another artificial reality environment, according to an example implementation of the present disclosure.

FIG. 6 is a block diagram of a computing environment, according to an example implementation of the present disclosure.

FIG. 7 is a block diagram of a system for using/determining/selecting preamble codes for UWB transmissions, according to an example implementation of the present disclosure.

FIG. 8A-FIG. 8B are preamble code tables corresponding to m-sequence preamble codes having a sequence length of 255, according to an example implementation of the present disclosure.

FIG. 9A-FIG. 9B are preamble code tables corresponding to m-sequence preamble codes having a sequence length of 511, according to an example implementation of the present disclosure.

FIG. 10A-FIG. 10B are preamble code tables corresponding to m-sequence preamble codes having a sequence length of 1023, according to an example implementation of the present disclosure.

FIG. 11A-FIG. 11B are preamble code tables corresponding to m-sequence preamble codes having a sequence length of 2047, according to an example implementation of the present disclosure.

FIG. 12A-FIG. 12C are preamble code tables including derived preamble codes having a sequence length of 15, according to an example implementation of the present disclosure.

FIG. 13 is a table showing metrics relating to the derived preamble code tables shown in FIG. 12A, according to an example implementation of the present disclosure.

FIG. 14A-FIG. 14C are preamble code tables including derived preamble codes having a sequence length of 17, according to an example implementation of the present disclosure.

FIG. 15A-FIG. 15B are preamble code tables including derived preamble codes having a sequence length of 19, according to an example implementation of the present disclosure.

FIG. 16 is a flowchart showing a method for selecting preamble codes for UWB transmissions, according to an example implementation of the present disclosure

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are embodiments related to devices operating in the ultra-wideband (UWB) spectrum. In various embodiments, UWB devices operate in the 3-10 GHz unlicensed spectrum using 500+ MHz channels which may require low power for transmission. For example, the transmit power spectral density (PSD) for some devices may be limited to −41.3 dBm/MHz. On the other hand, UWB may have transmit PSD values in the range of −5 to +5 dBm/MHz range, averaged over 1 ms, with a peak power limit of 0 dBm in a given 50 MHz band. Using simple modulation and spread spectrum, UWB devices may achieve reasonable resistance to Wi-Fi and Bluetooth interference (as well as resistance to interference with other UWB devices within a shared or common environment) for very low data rates (e.g., 10s to 100s Kbps) and may have large processing gains. However, for higher data rates (e.g., several Mbps), the processing gains may not be sufficient to overcome co-channel interference from Wi-Fi or Bluetooth. According to the embodiments described herein, the systems and methods described herein may operate in frequency bands that do not overlap with Wi-Fi and Bluetooth, but may have good global availability based on regulatory requirements. Since regulatory requirements make the 7-8 GHz spectrum the most widely available globally (and Wi-Fi is not present in this spectrum), the 7-8 GHz spectrum may operate satisfactory both based on co-channel interference and processing gains.

Some implementations of UWB may focus on precision ranging, security, and low to moderate rate data communication. As UWB employs relatively simple modulation, it may be implemented at low cost and low power consumption. In AR/VR applications, link budget calculations for an AR/VR controller link indicate that the systems and methods described herein may be configured for effective data throughput ranging from 18 2 to 31 Mbps (e.g., with 31 Mbps being the maximum possible rate in the latest 802.15.4z standard), which may depend on body loss assumptions. Using conservative body loss assumptions, the systems and methods described herein should be configured for data throughput of up to approximately 5 Mbps, which may be sufficient to meet the data throughput performance standards for AR/VR links. With a customized implementation, data throughput rate could be increased beyond 27 Mbps (e.g., to 54 Mbps), but with possible loss in link margin.

In various implementations, devices may leverage UWB devices or antennas 308 to exchange data communications. In some systems and methods, to exchange a data communication, a device may incorporate a preamble into the transmission frame or signal. The preamble may identify, signify, relate to, or otherwise be linked to a particular data channel or linkage between the devices. For example, two devices exchanging communications may use preambles which are known to the respective devices. When one of the devices receives a transmission frame or signal, the device may extract or otherwise identify the preamble from the signal. Upon determining that the preamble matches the known preamble of the other device, the device may determine that the device is the intended recipient of the signal and parse the body of the signal to extract its data/contents. In some instances, multiple devices may be located within a given environment. Such devices may communicate with other devices in the environment using different protocols including, for instance, UWB, WIFI, Bluetooth, etc. As part of multiple devices being co-located in an environment, interference or cross-talk communication metrics, such as autocorrelation and cross-correlation, become more important.

According to the systems and methods of the present solution, a device may be configured to select a first preamble code of a plurality of preamble codes for a data transmission to be sent via a UWB antenna or device to a second device. The preamble codes may have a suppression factor/metric/level/ratio (e.g., a sidelobe suppression ratio) of at least some threshold (such as 12 dB) with respect to another preamble code. The device may transmit the data transmission including the first preamble code with the UWB antenna to the second device. Rather than performing a trial-and-error or guess-and-check process of selecting (e.g., determining, identifying) preamble codes, the systems and methods described herein may perform a more targeted selection by determining suppression ratios (or other variants of such metrics) of a selected preamble code with respect to other preamble codes. For instance, the device may determine that another device in the environment is using a particular preamble code, and select another preamble code which satisfies a suppression criteria or threshold with respect to the particular preamble code.

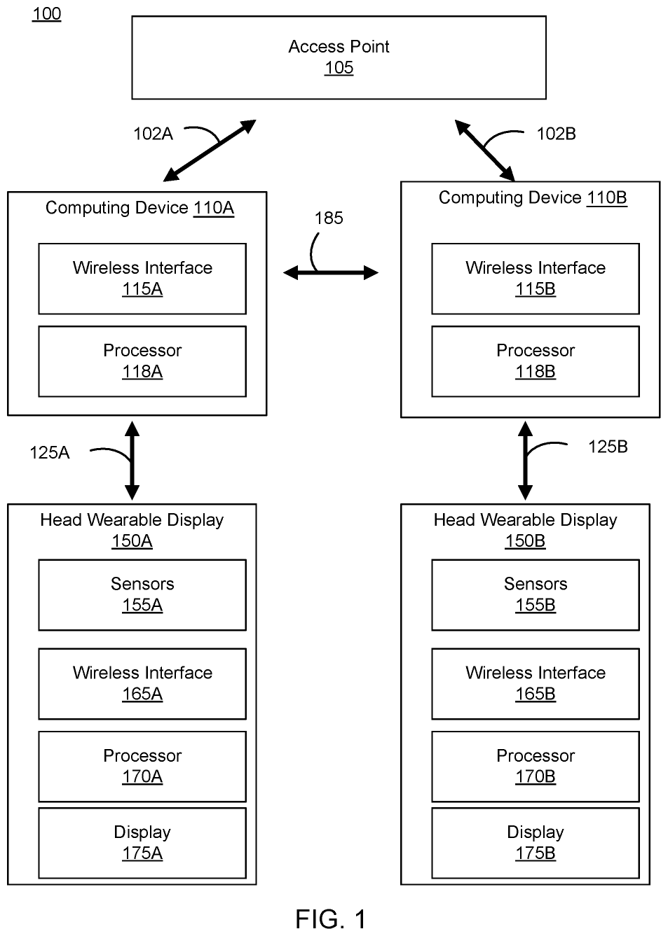

FIG. 1 is a block diagram of an example artificial reality system environment 100. In some embodiments, the artificial reality system environment 100 includes an access point (AP) 105, one or more HWDs 150 (e.g., HWD 150A, 150B), and one or more computing devices 110 (computing devices 110A, 110B; sometimes referred to as consoles) providing data for artificial reality to the one or more HWDs 150. The access point 105 may be a router or any network device allowing one or more computing devices 110 and/or one or more HWDs 150 to access a network (e.g., the Internet). The access point 105 may be replaced by any communication device (cell site). A computing device 110 may be a custom device or a mobile device that can retrieve content from the access point 105, and provide image data of artificial reality to a corresponding HWD 150. Each HWD 150 may present the image of the artificial reality to a user according to the image data. In some embodiments, the artificial reality system environment 100 includes more, fewer, or different components than shown in FIG. 1. In some embodiments, the computing devices 110A, 110B communicate with the access point 105 through wireless links 102A, 102B (e.g., interlinks), respectively. In some embodiments, the computing device 110A communicates with the HWD 150A through a wireless link 125A (e.g., intralink), and the computing device 110B communicates with the HWD 150B through a wireless link 125B (e.g., intralink). In some embodiments, functionality of one or more components of the artificial reality system environment 100 can be distributed among the components in a different manner than is described here. For example, some of the functionality of the computing device 110 may be performed by the HWD 150. For example, some of the functionality of the HWD 150 may be performed by the computing device 110.

In some embodiments, the HWD 150 is an electronic component that can be worn by a user and can present or provide an artificial reality experience to the user. The HWD 150 may be referred to as, include, or be part of a head mounted display (HMD), head mounted device (HMD), head wearable device (HWD), head worn display (HWD) or head worn device (HWD). The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155, a wireless interface 165, a processor 170, and a display 175. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detects a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the wireless interface 165 includes an electronic component or a combination of an electronic component and a software component that communicates with the computing device 110. In some embodiments, the wireless interface 165 includes or is embodied as a transceiver for transmitting and receiving data through a wireless medium. The wireless interface 165 may communicate with a wireless interface 115 of a corresponding computing device 110 through a wireless link 125 (e.g., intralink). The wireless interface 165 may also communicate with the access point 105 through a wireless link (e.g., interlink). Examples of the wireless link 125 include a near field communication link, Wi-Fi direct, Bluetooth, or any wireless communication link. In some embodiments, the wireless link 125 may include one or more ultra-wideband communication links, as described in greater detail below. Through the wireless link 125, the wireless interface 165 may transmit to the computing device 110 data indicating the determined location and/or orientation of the HWD 150, the determined gaze direction of the user, and/or hand tracking measurement. Moreover, through the wireless link 125, the wireless interface 165 may receive from the computing device 110 image data indicating or corresponding to an image to be rendered.

In some embodiments, the processor 170 includes an electronic component or a combination of an electronic component and a software component that generates one or more images for display, for example, according to a change in view of the space of the artificial reality. In some embodiments, the processor 170 is implemented as one or more graphical processing units (GPUs), one or more central processing unit (CPUs), or a combination of them that can execute instructions to perform various functions described herein. The processor 170 may receive, through the wireless interface 165, image data describing an image of artificial reality to be rendered, and render the image through the display 175. In some embodiments, the image data from the computing device 110 may be encoded, and the processor 170 may decode the image data to render the image. In some embodiments, the processor 170 receives, from the computing device 110 through the wireless interface 165, object information indicating virtual objects in the artificial reality space and depth information indicating depth (or distances from the HWD 150) of the virtual objects. In one aspect, according to the image of the artificial reality, object information, depth information from the computing device 110, and/or updated sensor measurements from the sensors 155, the processor 170 may perform shading, reprojection, and/or blending to update the image of the artificial reality to correspond to the updated location and/or orientation of the HWD 150.

In some embodiments, the display 175 is an electronic component that displays an image. The display 175 may, for example, be a liquid crystal display or an organic light emitting diode display. The display 175 may be a transparent display that allows the user to see through. In some embodiments, when the HWD 150 is worn by a user, the display 175 is located proximate (e.g., less than 3 inches) to the user's eyes. In one aspect, the display 175 emits or projects light towards the user's eyes according to image generated by the processor 170. The HWD 150 may include a lens that allows the user to see the display 175 in a close proximity.

In some embodiments, the processor 170 performs compensation to compensate for any distortions or aberrations. In one aspect, the lens introduces optical aberrations such as a chromatic aberration, a pin-cushion distortion, barrel distortion, etc. The processor 170 may determine a compensation (e.g., predistortion) to apply to the image to be rendered to compensate for the distortions caused by the lens, and apply the determined compensation to the image from the processor 170. The processor 170 may provide the predistorted image to the display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a wireless interface 115 and a processor 118. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. The computing device 110 may also communicate with the access point 105, and may obtain AR/VR content from the access point 105, for example, through the wireless link 102 (e.g., interlink). The computing device 110 may receive sensor measurement indicating location and the gaze direction of the user of the HWD 150 and provide the image data to the HWD 150 for presentation of the artificial reality, for example, through the wireless link 125 (e.g., intralink). In other embodiments, the computing device 110 includes more, fewer, or different components than shown in FIG. 1.

In some embodiments, the wireless interface 115 is an electronic component or a combination of an electronic component and a software component that communicates with the HWD 150, the access point 105, other computing device 110, or any combination of them. In some embodiments, the wireless interface 115 includes or is embodied as a transceiver for transmitting and receiving data through a wireless medium. The wireless interface 115 may be a counterpart component to the wireless interface 165 to communicate with the HWD 150 through a wireless link 125 (e.g., intralink). The wireless interface 115 may also include a component to communicate with the access point 105 through a wireless link 102 (e.g., interlink). Examples of wireless link 102 include a cellular communication link, a near field communication link, Wi-Fi, Bluetooth, 60 GHz wireless link, ultra-wideband link, or any wireless communication link. The wireless interface 115 may also include a component to communicate with a different computing device 110 through a wireless link 185. Examples of the wireless link 185 include a near field communication link, Wi-Fi direct, Bluetooth, ultra-wideband link, or any wireless communication link. Through the wireless link 102 (e.g., interlink), the wireless interface 115 may obtain AR/VR content, or other content from the access point 105. Through the wireless link 125 (e.g., intralink), the wireless interface 115 may receive from the HWD 150 data indicating the determined location and/or orientation of the HWD 150, the determined gaze direction of the user, and/or the hand tracking measurement. Moreover, through the wireless link 125 (e.g., intralink), the wireless interface 115 may transmit to the HWD 150 image data describing an image to be rendered. Through the wireless link 185, the wireless interface 115 may receive or transmit information indicating the wireless link 125 (e.g., channel, timing) between the computing device 110 and the HWD 150. According to the information indicating the wireless link 125, computing devices 110 may coordinate or schedule operations to avoid interference or collisions.

The processor 118 can include or correspond to a component that generates content to be rendered according to the location and/or orientation of the HWD 150. In some embodiments, the processor 118 includes or is embodied as one or more central processing units, graphics processing units, image processors, or any processors for generating images of the artificial reality. In some embodiments, the processor 118 may incorporate the gaze direction of the user of the HWD 150 and a user interaction in the artificial reality to generate the content to be rendered. In one aspect, the processor 118 determines a view of the artificial reality according to the location and/or orientation of the HWD 150. For example, the processor 118 maps the location of the HWD 150 in a physical space to a location within an artificial reality space, and determines a view of the artificial reality space along a direction corresponding to the mapped orientation from the mapped location in the artificial reality space. The processor 118 may generate image data describing an image of the determined view of the artificial reality space, and transmit the image data to the HWD 150 through the wireless interface 115. The processor 118 may encode the image data describing the image, and can transmit the encoded data to the HWD 150. In some embodiments, the processor 118 generates and provides the image data to the HWD 150 periodically (e.g., every 11 ms or 16 ms).

In some embodiments, the processors 118, 170 may configure or cause the wireless interfaces 115, 165 to toggle, transition, cycle or switch between a sleep mode and a wake up mode. In the wake up mode, the processor 118 may enable the wireless interface 115 and the processor 170 may enable the wireless interface 165, such that the wireless interfaces 115, 165 may exchange data. In the sleep mode, the processor 118 may disable (e.g., implement low power operation in) the wireless interface 115 and the processor 170 may disable the wireless interface 165, such that the wireless interfaces 115, 165 may not consume power or may reduce power consumption. The processors 118, 170 may schedule the wireless interfaces 115, 165 to switch between the sleep mode and the wake up mode periodically every frame time (e.g., 11 ms or 16 ms). For example, the wireless interfaces 115, 165 may operate in the wake up mode for 2 ms of the frame time, and the wireless interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced.

### Systems and Methods for Ultra-Wideband Devices

In various embodiments, the devices in the environments described above may operate or otherwise use components which leverage communications in the ultra-wideband (UWB) spectrum. In various embodiments, UWB devices operate in the 3-10 GHz unlicensed spectrum using 500+ MHz channels which may require low power for transmission. For example, the transmit power spectral density (PSD) for some systems may be limited to −41.3 dBm/MHz. On the other hand, UWB may have transmit PSD values in the range of −5 to +5 dBm/MHz range, averaged over 1 ms, with a peak power limit of 0 dBm in a given 50 MHz band. Using simple modulation and spread spectrum, UWB devices may achieve reasonable resistance to Wi-Fi and Bluetooth interference (as well as resistance to interference with other UWB devices located in the environment) for very low data rates (e.g., 10s to 100s Kbps) and may have large processing gains. However, for higher data rates (e.g., several Mbps), the processing gains may not be sufficient to overcome co-channel interference from Wi-Fi or Bluetooth. According to the embodiments described herein, the systems and methods described herein may operate in frequency bands that do not overlap with Wi-Fi and Bluetooth, but may have good global availability based on regulatory requirements. Since regulatory requirements make the 7-8 GHz spectrum the most widely available globally (and Wi-Fi is not present in this spectrum), the 7-8 GHz spectrum may operate satisfactory both based on co-channel interference and processing gains.

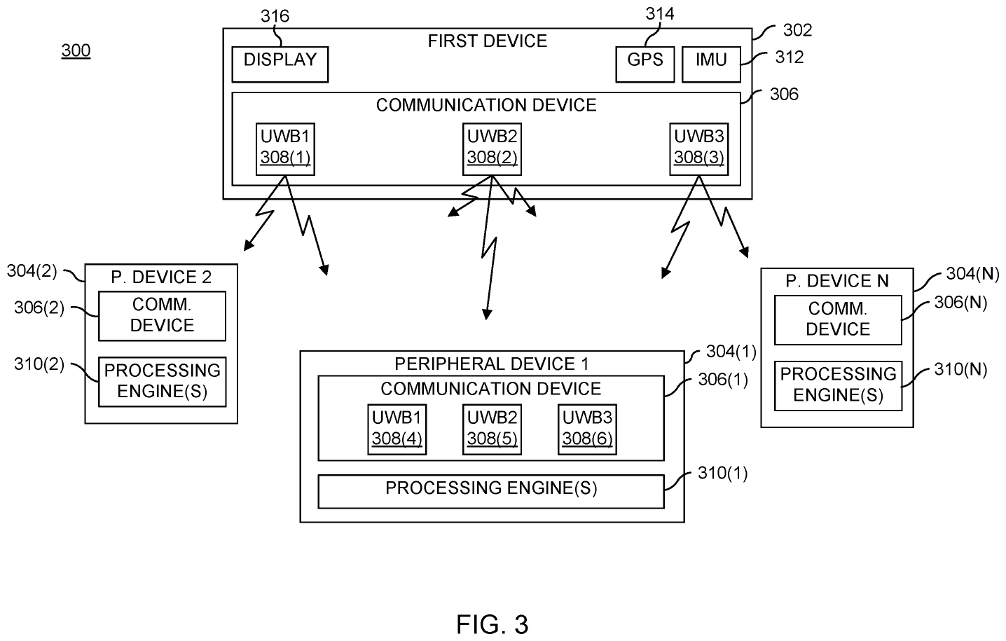

Some implementations of UWB may focus on precision ranging, security, and for low-to-moderate rate data communication. As UWB employs relatively simple modulation, it may be implemented at low cost and low power consumption. In AR/VR applications (or in other applications and use cases), link budget calculations for an AR/VR controller link indicate that the systems and methods described herein may be configured for effective data throughput ranging from ˜2 to 31 Mbps (e.g., with 31 Mbps being the maximum possible rate in the latest 802.15.4z standard), which may depend on body loss assumptions Referring now to FIG. 3, depicted is a block diagram of an artificial reality environment 300. The artificial reality environment 300 is shown to include a first device 302 and one or more peripheral devices 304(1)-304(N) (also referred to as “peripheral device 304” or “device 304”). The first device 302 and peripheral device(s) 304 may each include a communication device 306 including a plurality of UWB devices 308. A set of UWB devices 308 may be spatially positioned/located (e.g., spaced out) relative to each other on different locations on/in the first device 302 or the peripheral device 304, so as to maximize UWB coverage and/or to enhance/enable specific functionalities. The UWB devices 308 may be or include antennas, sensors, or other devices and components designed or implemented to transmit and receive data or signals in the UWB spectrum (e.g., between 3.1 GHz and 10.6 GHz) and/or using UWB communication protocol. In some embodiments, one or more of the devices 302, 304 may include various processing engines 310. The processing engines 310 may be or include any device, component, machine, or other combination of hardware and software designed or implemented to control the devices 302, 304 based on UWB signals transmitted and/or received by the respective UWB devices 308.

As noted above, the environment 300 may include a first device 302. The first device 302 may be or include a wearable device, such as the HWD 150 described above, a smart watch, AR glasses, or the like. In some embodiments, the first device 302 may include a mobile device (e.g., a smart phone, tablet, console device, or other computing device). The first device 302 may be communicably coupled with various other devices 304 located in the environment 300. For example, the first device 302 may be communicably coupled to one or more of the peripheral devices 304 located in the environment 300. The peripheral devices 304 may be or include the computing device 110 described above, a device similar to the first device 302 (e.g., a HWD 150, a smart watch, mobile device, etc.), an automobile or other vehicle, a beacon transmitting device located in the environment 300, a smart home device (e.g., a smart television, a digital assistant device, a smart speaker, etc.), a smart tag configured for positioning on various devices, etc. In some embodiments, the first device 302 may be associated with a first entity or user and the peripheral devices 304 may be associated with a second entity or user (e.g., a separate member of a household, or a person/entity unrelated to the first entity).

In some embodiments, the first device 302 may be communicably coupled with the peripheral device(s) 304 following a pairing or handshaking process. For example, the first device 302 may be configured to exchange handshake packet(s) with the peripheral device(s) 304, to pair (e.g., establish a specific or dedicated connection or link between) the first device 302 and the peripheral device 304. The handshake packet(s) may be exchanged via the UWB devices 308, or via another wireless link 125 (such as one or more of the wireless links 125 described above). Following pairing, the first device 302 and peripheral device(s) 304 may be configured to transmit, receive, or otherwise exchange UWB data or UWB signals using the respective UWB devices 308 on the first device 302 and/or peripheral device 304. In some embodiments, the first device 302 may be configured to establish a communications link with a peripheral device 304 (e.g., without any device pairing). For example, the first device 302 may be configured to detect, monitor, and/or identify peripheral devices 304 located in the environment using UWB signals received from the peripheral devices 304 within a certain distance of the first device 302, by identifying peripheral devices 304 which are connected to a shared Wi-Fi network (e.g., the same Wi-Fi network to which the first device 302 is connected), etc. In these and other embodiments, the first device 302 may be configured to transmit, send, receive, or otherwise exchange UWB data or signals with the peripheral device 304.

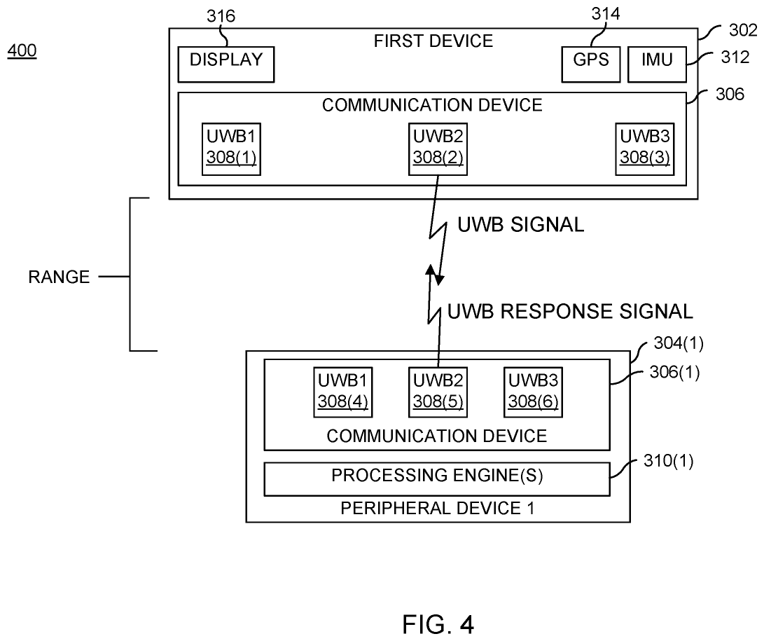

Referring now to FIG. 4, depicted is a block diagram of an environment 400 including the first device 302 and a peripheral device 304. The first device 302 and/or the peripheral device 304 may be configured to determine a range (e.g., a spatial distance, separation) between the devices 302, 304. The first device 302 may be configured to send, broadcast, or otherwise transmit a UWB signal (e.g., a challenge signal). The first device 302 may transmit the UWB signal using one of the UWB devices 308 of the communication device 306 on the first device 302. The UWB device 308 may transmit the UWB signal in the UWB spectrum. The UWB signal may have a high bandwidth (e.g., 500 MHz). As such, the UWB device 308 may be configured to transmit the UWB signal in the UWB spectrum (e.g., between 3.1 GHz and 10.6 GHz) and having a high bandwidth (e.g., 500 MHz). The UWB signal from the first device 302 may be detectable by other devices within a certain range of the first device 302 (e.g., devices having a line of sight (LOS) within 200 m of the first device 302). As such, the UWB signal may be more accurate for detecting range between devices than other types of signals or ranging technology.

The peripheral device 304 may be configured to receive or otherwise detect the UWB signal from the first device 302. The peripheral device 304 may be configured to receive the UWB signal from the first device 302 via one of the UWB devices 308 on the peripheral device 304. The peripheral device 304 may be configured to broadcast, send, or otherwise transmit a UWB response signal responsive to detecting the UWB signal from the first device 302. The peripheral device 304 may be configured to transmit the UWB response signal using one of the UWB devices 308 of the communication device 306 on the peripheral device 304. The UWB response signal may be similar to the UWB signal sent from the first device 302.

The first device 302 may be configured to detect, compute, calculate, or otherwise determine a time of flight (TOF) based on the UWB signal and the UWB response signal. The TOF may be a time or duration between a time in which a signal (e.g., the UWB signal) is transmitted by the first device 302 and a time in which the signal is received by the peripheral device 304. The first device 302 and/or the peripheral device 304 may be configured to determine the TOF based on timestamps corresponding to the UWB signal. For example, the first device 302 and/or peripheral device 304 may be configured to exchange transmit and receive timestamps based on when the first device 302 transmits the UWB signal (a first TX timestamp), when the peripheral device receives the UWB signal (e.g., a first RX timestamp), when the peripheral device sends the UWB response signal (e.g., a second TX timestamp), and when the first device 302 receives the UWB response signal (e.g., a second RX timestamp). The first device 302 and/or the peripheral device 304 may be configured to determine the TOF based on a first time in which the first device 302 sent the UWB signal and a second time in which the first device 302 received the UWB response signal (e.g., from the peripheral device 304), as indicated by first and second TX and RX timestamps identified above. The first device 302 may be configured to determine or calculate the TOF between the first device 302 and the peripheral device 304 based on a difference between the first time and the second time (e.g., divided by two).

In some embodiments, the first device 302 may be configured to determine the range (or distance) between the first device 302 and the peripheral device 304 based on the TOF. For example, the first device 302 may be configured to compute the range or distance between the first device 302 and the peripheral device 304 by multiplying the TOF and the speed of light (e.g., TOF×c). In some embodiments, the peripheral device 304 (or another device in the environment 400) may be configured to compute the range or distance between the first device 302 and peripheral device 304. For example, the first device 302 may be configured to transmit, send, or otherwise provide the TOF to the peripheral device 304 (or other device), and the peripheral device 304 (or other device) may be configured to compute the range between the first device 302 and peripheral device 304 based on the TOF, as described above.

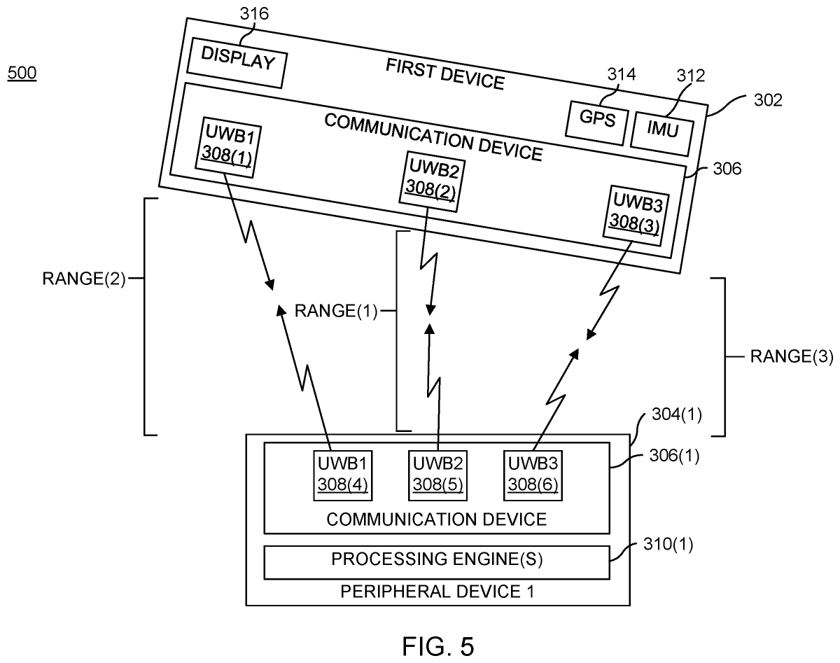

Referring now to FIG. 5, depicted is a block diagram of an environment 500 including the first device 302 and a peripheral device 304. In some embodiments, the first device 302 and/or the peripheral device 304 may be configured to determine a position or pose (e.g., orientation) of the first device 302 relative to the peripheral device 304. The first device 302 and/or the peripheral device 304 may be configured to determine the relative position or orientation in a manner similar to determining the range as described above. For example, the first device 302 and/or the peripheral device 304 may be configured to determine a plurality of ranges (e.g., range(1), range(2), and range(3)) between the respective UWB devices 308 of the first device 302 and the peripheral device 304. In the environment 500 of FIG. 5, the first device 302 is positioned or oriented at an angle relative to the peripheral device 304. The first device 302 may be configured to compute the first range (range(1)) between central UWB devices 308(2), 308(5) of the first and peripheral device 304. The first range may be an absolute range or distance between the devices 302, 304, and may be computed as described above with respect to FIG. 4.

The first device 302 and/or the peripheral device 304 may be configured to compute the second range(2) and third range(3) similar to computing the range(1), In some embodiments, the first device 302 and/or the peripheral device 304 may be configured to determine additional ranges, such as a range between UWB device 308(1) of the first device 302 and UWB device 308(5) of the peripheral device 304, a range between UWB device 308(2) of the first device 302 and UWB device 308(6) of the peripheral device 304, and so forth. While described above as determining a range based on additional UWB signals, it is noted that, in some embodiments, the first device 302 and/or the peripheral device 304 may be configured to determine a phase difference between a UWB signal received at a first UWB device 308 and a second UWB device 308 (i.e., the same UWB signal received at separate UWB devices 308 on the same device 302, 304). The first device 302 and/or the peripheral device 304 may be configured to use each or a subset of the computed ranges (or phase differences) to determine the pose, position, orientation, etc. of the first device 302 relative to the peripheral device 304. For example, the first device and/or the peripheral device 304 may be configured to use one of the ranges relative to the first range(1) (or phase differences) to determine a yaw of the first device 302 relative to the peripheral device 304, another one of the ranges relative to the first range(1) (or phase differences) to determine a pitch of the first device 302 relative to the peripheral device 304, another one of the ranges relative to the first range(1) (or phase differences) to determine a roll of the first device 302 relative to the peripheral device 304, and so forth.

By using the UWB devices 308 at the first device 302 and peripheral devices 304, the range and pose may be determined with greater accuracy than other ranging/wireless link technologies. For example, the range may be determined within a granularity or range of +/−0.1 meters, and the pose/orientation may be determined within a granularity or range of +/−5 degrees.

Referring to FIG. 3-FIG. 5, in some embodiments, the first device 302 may include various sensors and/or sensing systems. For example, the first device 302 may include an inertial measurement unit (IMU) sensor 312, global positioning system (GPS) 314, etc. The sensors and/or sensing systems, such as the IMU sensor 312 and/or GPS 314 may be configured to generate data corresponding to the first device 302. For example, the IMU sensor 312 may be configured to generate data corresponding to an absolute position and/or pose of the first device 302. Similarly, the GPS 314 may be configured to generate data corresponding to an absolute location/position of the first device 302. The data from the IMU sensor 312 and/or GPS 314 may be used in conjunction with the ranging/position data determined via the UWB devices 308 as described above. In some embodiments, the first device 302 may include a display 316. The display 316 may be integrated or otherwise incorporated in the first device 302. In some embodiments, the display 316 may be separate or remote from the first device 302. The display 316 may be configured to display, render, or otherwise provide visual information to a user or wearer of the first device 302, which may be rendered at least in part on the ranging/position data of the first device 302.

One or more of the devices 302, 304 may include various processing engine(s) 310. As noted above, the processing engine(s) 310 may be or include any device, component, machine, or combination of hardware and software designed or implemented to control the devices 302, 304 based on UWB signals transmitted and/or received by the respective UWB devices 308. In some embodiments, the processing engine(s) 310 may be configured to compute or otherwise determine the ranges/positions of the first device 302 relative to the peripheral devices 304 as described above. In some embodiments, the processing engines 310 may be located or embodied on another device in the environment 300-500 (such as at the access point 105 as described above with respect to FIG. 1). As such, the first device 302 and/or peripheral devices 304 may be configured to off-load computation to another device in the environment 300-500 (such as the access point 105). In some embodiments, the processing engines 310 may be configured to perform various functions and computations relating to radio transmissions and scheduling (e.g., via the UWB devices 308 and/or other communication interface components), compute or otherwise determine range and relative position of the devices 302, 304, manage data exchanged between the devices 302, 304, interface with external components (such as hardware components in the environment 300-500, external software or applications, etc.), and the like. Various examples of functions and computations which may be performed by the processing engine(s) 310 are described in greater detail below.

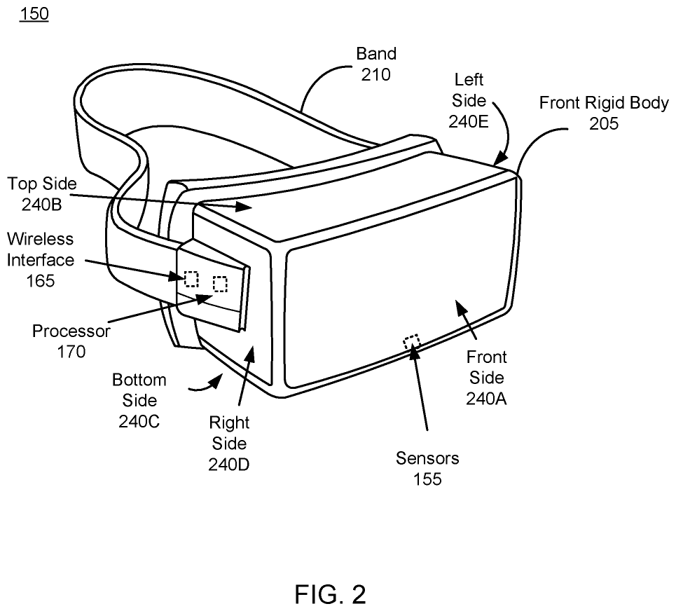

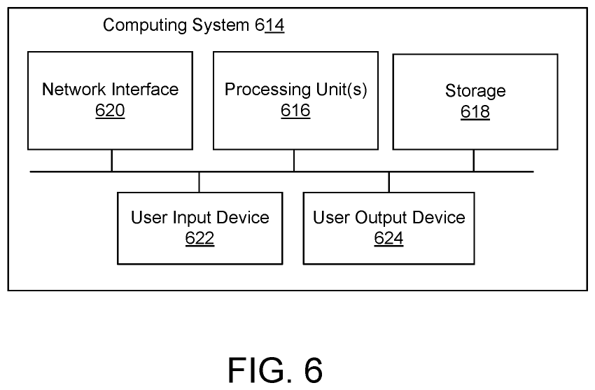

Various operations described herein can be implemented on computer systems. FIG. 6 shows a block diagram of a representative computing system 614 usable to implement the present disclosure. In some embodiments, the computing device 110, the HWD 150, devices 302, 304, or each of the components of FIG. 1-5 are implemented by or may otherwise include one or more components of the computing system 614. Computing system 614 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 614 can be implemented to provide VR, AR, MR experience. In some embodiments, the computing system 614 can include conventional computer components such as processors 616, storage device 618, network interface 620, user input device 622, and user output device 624.

Network interface 620 can provide a connection to a wide area network (e.g., the Internet) to which WAN interface of a remote server system is also connected. Network interface 620 can include a wired interface (e.g., Ethernet) and/or a wireless interface implementing various RF data communication standards such as Wi-Fi, Bluetooth, UWB, or cellular data network standards (e.g., 3G, 4G, 5G, 60 GHz, LTE, etc.).

User input device 622 can include any device (or devices) via which a user can provide signals to computing system 614; computing system 614 can interpret the signals as indicative of particular user requests or information. User input device 622 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 624 can include any device via which computing system 614 can provide information to a user. For example, user output device 624 can include a display to display images generated by or delivered to computing system 614. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 624 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 616 can provide various functionality for computing system 614, including any of the functionality described herein as being performed by a server or client, or other functionality associated with message management services.

It will be appreciated that computing system 614 is illustrative and that variations and modifications are possible. Computer systems used in connection with the present disclosure can have other capabilities not specifically described here. Further, while computing system 614 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

### Systems and Methods for Preambles for UWB Transmissions

In various implementations, devices 302, 304 may leverage UWB devices or antennas 308 to exchange data communications. In some systems and methods, to exchange a data communication, a device may incorporate a preamble into the transmission frame or signal. The preamble may identify, signify, relate to, or otherwise be linked to a particular data channel or linkage between the devices. For example, two devices exchanging communications may use preambles which are known to the respective devices. When one of the devices receives a transmission frame or signal, the device may extract or otherwise identify the preamble from the signal. Upon determining that the preamble matches the known preamble of the other device, the device may determine that the device is the intended recipient of the signal and can parse the body of the signal to extract its data/contents. In some instances, multiple devices may be located within a given environment. Such devices may communicate with other devices in the environment using different protocols including, for instance, UWB, WIFI, Bluetooth, etc. As part of multiple devices being co-located in an environment, interference or cross-talk communication metrics, such as autocorrelation and cross-correlation, become important.

According to the systems and methods of the present solution, a device (such as device 302, 304) may be configured to select a first preamble code of a plurality of preamble codes for a data transmission to be sent via a UWB antenna or device 308 to a second device. The preamble codes may have a sidelobe suppression ratio/metric (e.g., an interference or cross-talk communication metric, such as or incorporating autocorrelation and/or cross-correlation metric(s)) of at least some threshold (such as 12 dB) with respect to another preamble code. The device may transmit the data transmission including the first preamble code with the UWB antenna to the second device. Rather than performing a trial-and-error or guess-and-check process of selecting preamble codes, the systems and methods described herein may perform a more targeted selection by determining suppression ratios of a selected preamble code with respect to other preamble codes. For instance, the device may determine that another device in the environment is using a particular preamble code, and select another preamble code which satisfies a suppression criteria or threshold with respect to the particular preamble code.

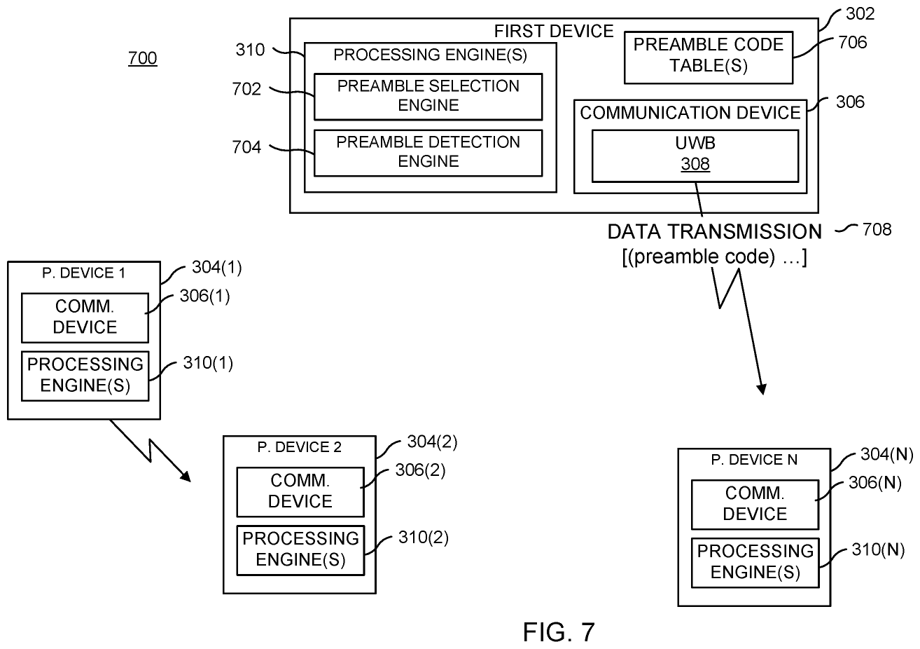

Referring now to FIG. 7, depicted is a system 700 for selecting preamble codes for UWB transmissions according to an example implementation of the present disclosure. The system 700 is shown to include the first device 302 and peripheral devices 304 described above with reference to FIG. 1A-FIG. 5. The devices 302, 304 may include the processing engine(s) 310, communications device 306, and other components/elements/hardware described above with reference to FIG. 1A-FIG. 5. The processing engine(s) 310 may include, for instance, a preamble selection engine 702 and a preamble detection engine 704. As described in greater detail below, the preamble selection engine 702 may be configured to select a preamble code from a plurality of preamble codes for a data transmission sent via the UWB device or antenna 308 (referred to hereinafter as “UWB antenna 308”) to another device in the environment. The preamble codes may have a sidelobe suppression ratio of at least 12 dB with respect to another preamble code. The device 302 (e.g., the communication device 306) may be configured to transmit a data transmission including the selected preamble code via the UWB antenna 308 to the other device.

As shown in FIG. 7, the system 700 may include several devices 302, 304 within the environment (e.g., the first device 302 and various peripheral devices 304). Some of the peripheral devices 304 may communicate using a protocol which is different (e.g., separate) from the UWB protocol. For example, the first peripheral device 304(1) may communicate with the second peripheral device 304(2) via Bluetooth, WIFI, etc. As part of such communications, the first peripheral device 304(1) and second peripheral devices 304(2) may be configured to establish, set, determine, or otherwise define a preamble for data transmissions sent by the respective devices 304(1), 304(2). While shown as two peripheral devices 304, it is noted that the environment may include any number of peripheral devices 304, some of which may communicate via UWB while others may communicate via other communications protocols.

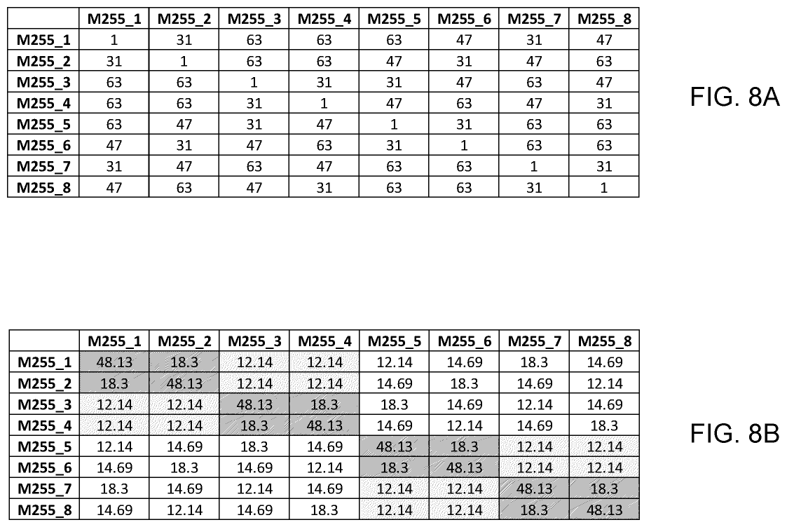

The processing engines 310 may include a preamble selection engine 702. The preamble selection engine 702 may be or include any device, component, element, or combination of hardware configured to select a preamble code for incorporation into or use in a data transmission to be sent to another device 302, 304 in the environment. In some embodiments, the preamble selection engine 702 may be configured to select the preamble code from a preamble code table 706. The preamble code table 706 may be or include various preamble code tables described below with reference to FIG. 8A-FIG. 15B. In some embodiments, the preamble code table(s) 706 may be deployed, installed, or otherwise accessed locally at the device 302. In some embodiments, the preamble code table(s) 706 may be accessed from a remote data structure (e.g., the preamble code table(s) 706 may be stored or maintained at a remote data structure and accessed by the preamble selection engine 702).

As a general overview, the preamble code tables 706 may include preamble codes which have various metrics relating to autocorrelation and/or cross-correlation sidelobe suppression ratios. The sidelobe suppression ratios may be or include a metric or ratio indicating a degree or amount of signal radiation/interference from the UWB antenna 308 which is not in the direction of the main lobe towards the target (e.g., towards the other device). As such, as the sidelobe suppression ratio increases, the degree or amount of signal radiation from the UWB antenna 308 outside of the direction of the main lobe correspondingly decreases. The sidelobe suppression ratio may be computed as

$$20 log 10 ( \frac{auto correlation peak}{cross - correlation peak} ) .$$

The autocorrelation sidelobe suppression ratio may be indicative of an estimation or likelihood data transmissions occurring on the same channel (e.g., as opposed to a different channel) over successive transmissions. The cross-correlation sidelobe suppression ratio may be indicative of coexistence properties between other devices within the environment. Having a good autocorrelation sidelobe suppression ratio and/or cross-correlation sidelobe suppression ratio may provide better channel estimation, coexistence properties with other high-speed UWB-compatible devices (including those with high rate pulse repetition frequency and low pulse repetition frequency or other legacy UWB devices).

The preamble selection engine 702 may be configured to select a preamble code from the preamble code table 706. In some embodiments, the preamble selection engine 702 may be configured to execute one or more algorithms or routines for selecting the preamble code table 706. In some embodiments, the preamble selection engine 702 may be configured to select an initial preamble code according to a default setting or selection rule. The preamble selection engine 702 may be configured to select additional or alternative preamble codes based on detected codes detected or determined to be in use within the environment, as described in greater detail below.

In some embodiments, the preamble selection engine 702 may be configured to negotiate the selection of the preamble code with another device (such as the peripheral device 304(N)) to which the device 302 is to send a data transmission. For example, as part of pairing with another device, or establishing, determining, or negotiating a channel or link between two devices 302, 304, the devices 302, 304 may be configured to select and share preamble codes with each other. The devices 302, 304 may be configured to select preamble codes which correspond to each other from the preamble code tables 706. The devices 302, 304 may be configured to identify from predefined/preconfigured preamble codes, or exchange and store preamble codes of other devices 304, 302 as part of establishing the session, link, or channel between the devices 302, 304. The devices 302, 304 may be configured to exchange preamble codes such that, upon receiving a subsequent data transmission with the preamble code, the devices 302, 304 may be configured to determine that they are the intended recipient of the data transmission (e.g., based on the preamble code matching a stored preamble code).

The processing engines 310 may include a preamble detection engine 704. The preamble detection engine 704 may be or include any device, component, element, or combination of hardware configured to detect a preamble code in use in a data transmission by another device 302, 304 in the environment. In some embodiments, the preamble detection engine 704 may be configured to detect a preamble code from a data transmission sent by another device 302, 304 with a different device (e.g., other than the detecting device) as an intended recipient. For example, the preamble detection engine 704 of the first device 302 may be configured to detect, identify, or otherwise determine that a preamble code is being used by the first peripheral device 304(1) for transmissions sent to the second peripheral device 304(2). The preamble detection engine 704 may be configured to determine that the preamble code is being used by the first peripheral device 304(1) based on receiving the transmission sent by the first peripheral device 304(1). The preamble detection engine 704 may be configured to extract, identify, or otherwise detect the preamble code from the transmission sent by the first peripheral device 304(1) (e.g., without parsing or inspecting the entirety of the transmission).

The preamble selection engine 702 may be configured to select or identify a preamble code based on the detected preamble codes currently in use in the environment. For example, the preamble selection engine 702 may be configured to select a preamble code based on a sidelobe suppression ratio for the selected preamble code with respect to detected preamble codes in the environment. The preamble selection engine 702 may be configured to select the preamble code to have a sidelobe suppression ratio which satisfies a selection threshold criteria with respect to the detected preamble code. The selection threshold criteria may depend on the particular preamble code type used or selected by the preamble selection engine 702. The selection threshold criteria may depend on a length of the preamble code selected by the preamble selection engine 702. These examples are described in greater detail below.

The communication device 306 may be configured to transmit, send, or otherwise provide the data transmission 708 using the selected preamble code. In some embodiments, the communication device 306 may be configured to receive a body of the data transmission 708 from another component or element of the device 302. The communication device 306 may be configured to produce, determine, derive, otherwise generate the data transmission 708 by incorporating the preamble code selected by the preamble selection engine 702 into the body for the data transmission 708. The communication device 306 may be configured to send, communicate, broadcast, or otherwise transmit the data transmission via the UWB antenna 308 to another device (such as peripheral device 304(N)).

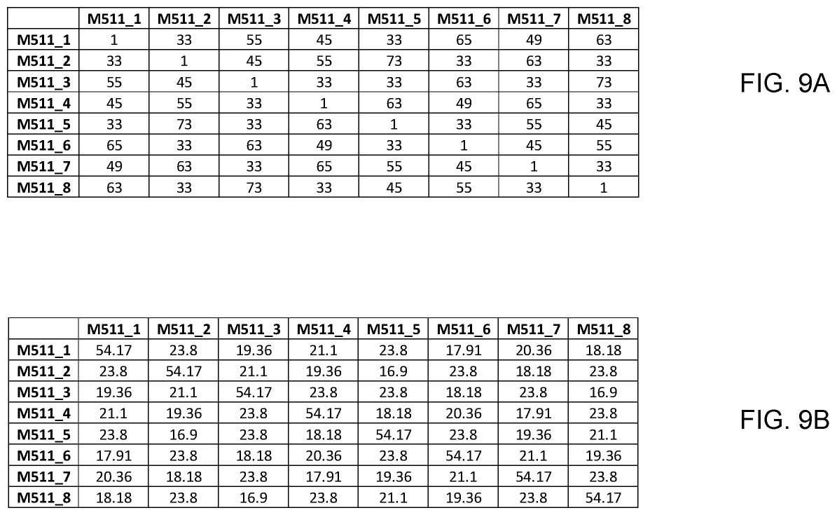

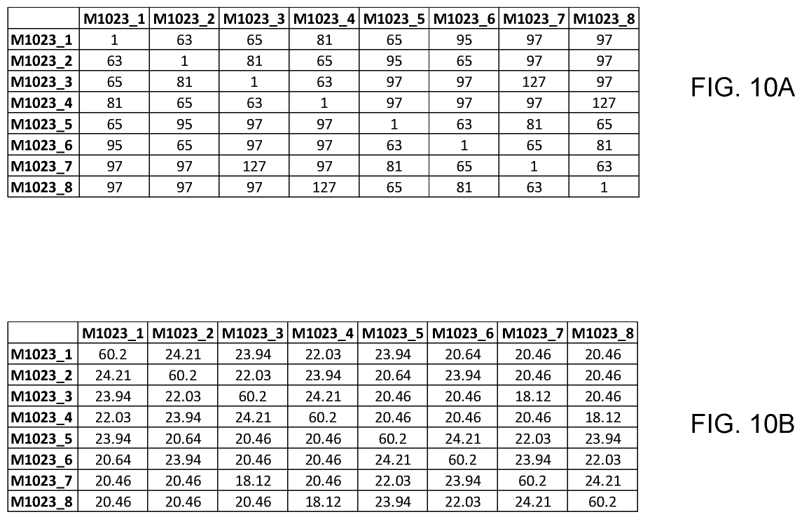

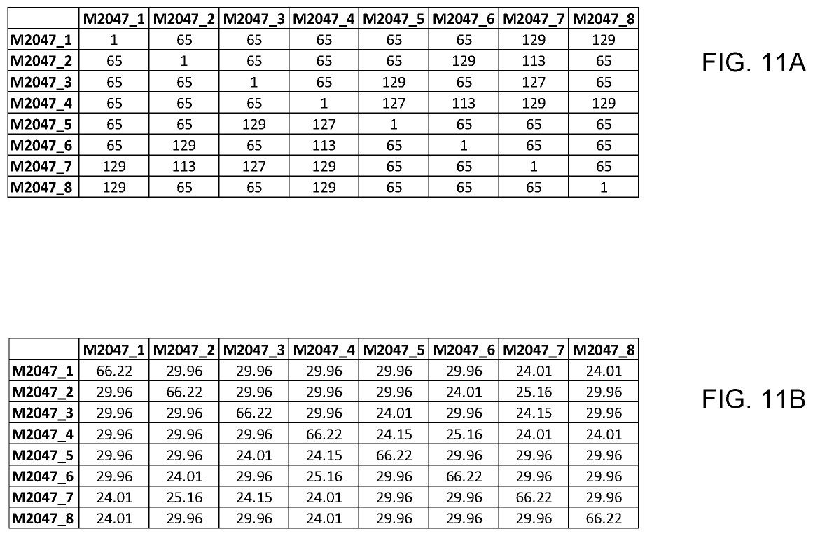

Referring generally to FIG. 8A-FIG. 15B, depicted are various examples of preamble code tables which may be maintained by, incorporated in, or otherwise accessed by the devices 302, 304 described herein. FIG. 8A-FIG. 11B show preamble code tables corresponding to m-sequence preamble codes having different code lengths (e.g., sequence length of 255 for the preamble code tables shown FIG. 8A-FIG. 8B, sequence length of 511 for the preamble code tables shown FIG. 9A-FIG. 9B, sequence length of 1023 for the preamble code tables shown FIG. 10A-FIG. 10B, and sequence length of 2047 for the preamble code tables shown FIG. 11A-FIG. 11B). The m-sequence preamble codes may have, include, or comprise characters from an alphabet including {1, −1}. The preamble code tables shown in FIG. 8A-FIG. 11B include an autocorrelation sidelobe suppression ratio (shown in FIGS. 8A, 9A, 10A, and 11A) and a cross-correlation sidelobe suppression ratio (shown in FIGS. 8B, 9B, 10B, and 11B) for transmit and receive preamble codes.

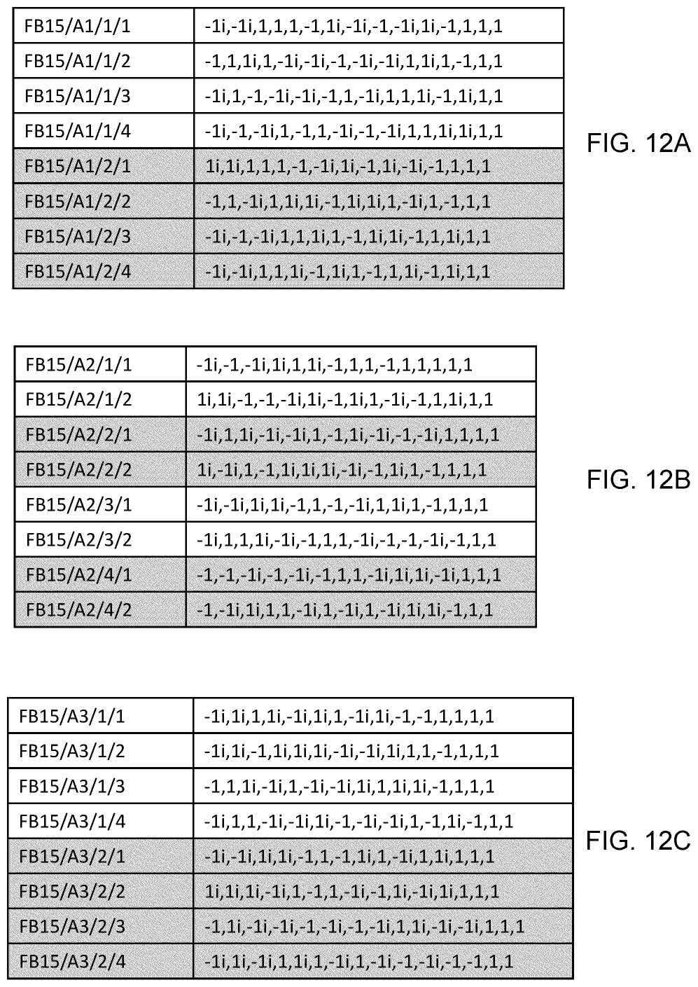

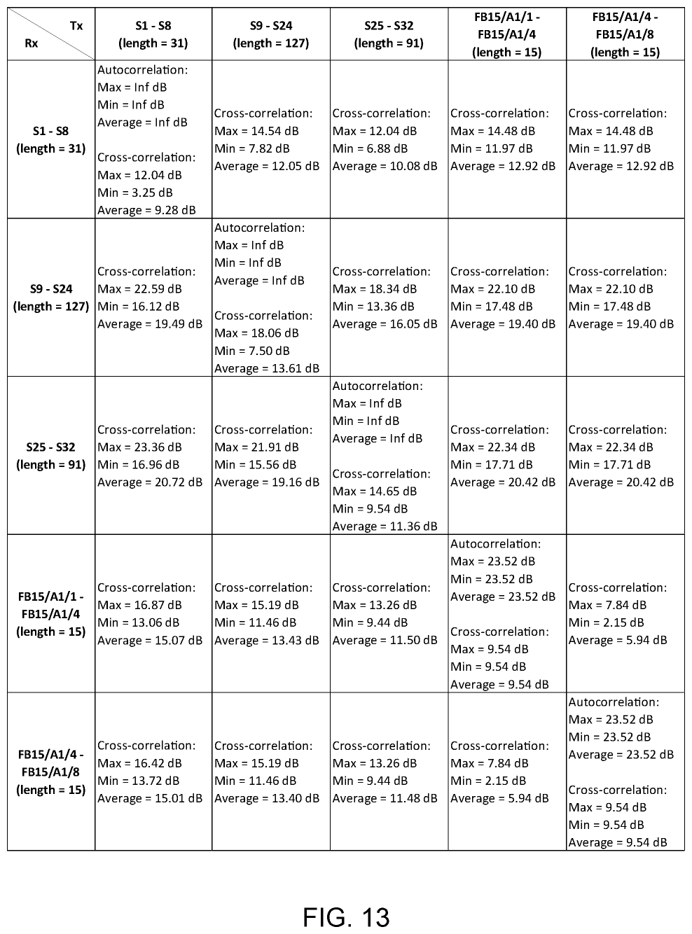

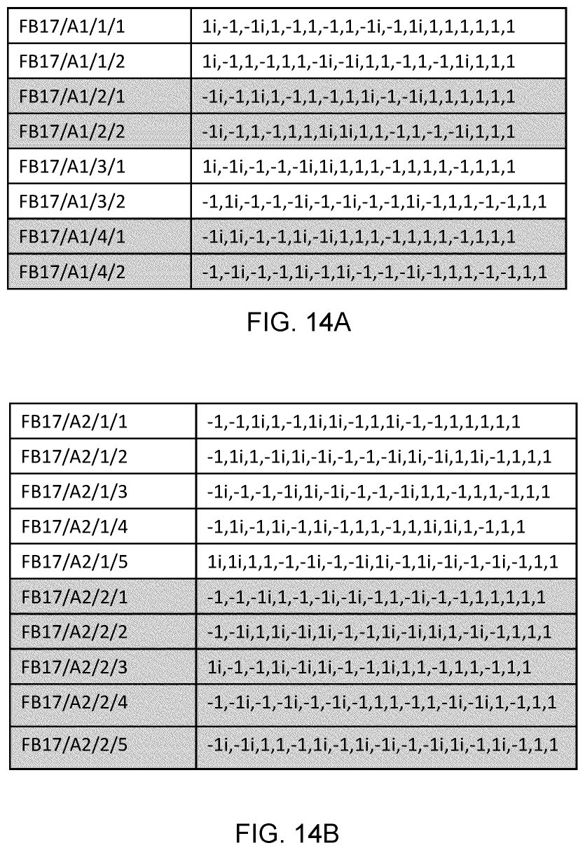

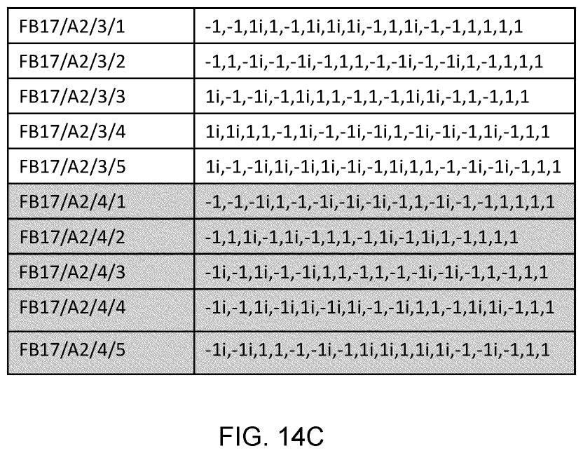

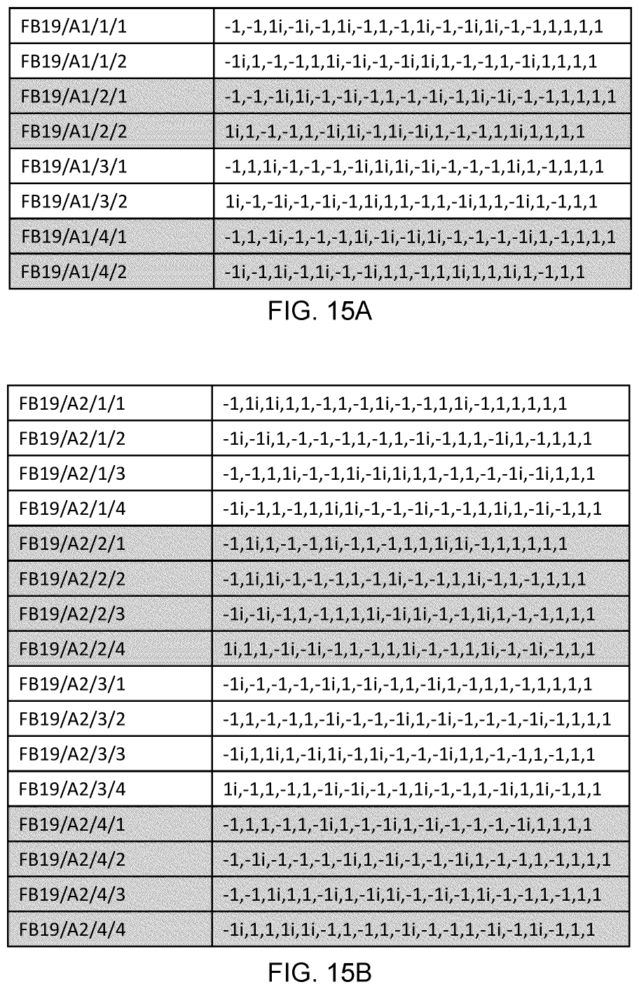

FIG. 12A-FIG. 12B and FIG. 14A-FIG. 15B show preamble code tables including derived preamble codes having different sequence lengths (e.g., sequence length of 15 for the preamble code tables shown in FIG. 12A-FIG. 12B, sequence code length of 17 for the preamble code tables shown in FIG. 14A-FIG. 14B, and sequence code length of 19 for the preamble code tables shown in FIG. 15A-FIG. 15B). The derived preamble codes may have, include, or comprise characters from an alphabet including {1, −1, i, −i}. FIG. 13 shows metrics for the preamble code table shown FIG. 12A relating to cross-correlation and autocorrelation sidelobe suppression ratios. While metrics for the preamble codes shown in FIG. 13 are provided, it is noted that similar metrics may also be applicable to the preamble codes shown in FIG. 12B-FIG. 12C. Additionally, better performing metrics may be applicable to the preamble codes shown in FIG. 14A-FIG. 15B, given that these codes have a longer sequence length and therefore may have better performance for autocorrelation and cross-correlation sidelobe suppression ratios. It is noted that, while the preamble codes described herein include m-sequence or derived preamble codes, in various implementations, the preamble selection engine 702 may be configured to apply one or more cyclic shifts (e.g., character shifts) to the preamble codes.

Referring to FIG. 7 and FIG. 8A-FIG. 8B, the preamble selection engine 702 may be configured to access the preamble code tables to select a preamble code to use for transmitting data transmissions. In some embodiments, the preamble selection engine 702 may be configured to access the preamble code tables shown in FIG. 8A-FIG. 8B to select a corresponding m-sequence preamble code having a sequence length of 255. It is noted that different preamble code tables (including those shown in FIG. 9A-FIG. 15B may be accessed according to different design choices or applications. However, in at least some of these examples, the preamble selection engine 702 may be configured to select preamble codes from the corresponding preamble code table(s) using the same or similar logic/rules/algorithms as set forth herein.

As shown in FIG. 8B, the preamble code table may include groupings of metrics relating to autocorrelation sidelobe suppression ratios for the transmit/receive preamble codes. Specifically, M255_1, M255_2 for both transmit and receive devices may be grouped in one grouping (a first group or subset), M255_3, M255_4 for both transmit and receive devices may be grouped in another grouping (a second subset), M255_5, M255_6 for both transmit and receive devices may be grouped in another grouping (a third subset), and M255_7, M255_8 for both transmit and receive devices may grouped in yet another grouping (a fourth subset). Similarly, the M255_3, M255_4 transmit may be grouped with the M255_1, M255_2 receive in a secondary grouping (e.g., a fifth subset), and vice versa. Finally, the M255_7, M2558 transmit may be grouped with the M255_5, M255_6 receive in a secondary grouping (e.g., a sixth subset), and vice versa. As shown within these groupings or subsets, the sidelobe suppression ratio may be greater than 12 dB (e.g., greater than 18.3 dB for primary groupings, or the first, second, third, and fourth subsets, and greater than 12 for secondary groupings). Similar groupings may be established or provided for the other m-sequence and/or derived preamble codes, based on respective sidelobe suppression ratios.

The preamble selection engine 702 may be configured to select an initial preamble code based on, using, or according to the preamble code tables. For example, the preamble selection engine 702 may be configured to default selecting a first preamble code from the first subset or grouping (e.g., M255_1, M255_2 for transmit/receive devices). The preamble selection engine 702 may be configured to share, send, indicate, or otherwise identify the selected preamble code to the intended device recipient (e.g., the N-th peripheral device 304(N) in the example shown in FIG. 7). The preamble selection engine 702 may be configured to identify the selected preamble code to the N-th peripheral device 304(N) as part of negotiating (e.g., configuring or setting up) the session or channel between the devices 302, 304(N). The communication device 306 may be configured to incorporate the selected (e.g., first) preamble code into a data transmission 708 sent to the N-th peripheral device 304(N).

In various instances, other devices 304 within the environment may use preamble codes which are near or adjacent to (e.g., may be within the same grouping or subsets) the selected preamble code. For example, the preamble detection engine 704 may be configured to detect, identify, or otherwise receive a data transmission sent by another device (e.g., peripheral device 304(1)) which is using a preamble code from the first subset (e.g., from the same subset in which the selected preamble code is included). The preamble detection engine 704 may be configured to extract or otherwise identify the preamble code from the data transmission received from the other device 304(1). The preamble detection engine 704 may be configured to determine to switch preamble codes responsive to identifying a preamble code from the data transmission which is included in the same grouping or subset as the first selected preamble code (e.g., the first subset).

The preamble selection engine 702 may be configured to select a different preamble code using the preamble code table responsive to determining that another device is using the same or related preamble code (e.g., a code from the same grouping or subset). In some embodiments, the preamble selection engine 702 may be configured to select a different preamble code from a different grouping or subset. For example, where the other device is using a preamble code from the first subset (e.g., M255_1, M255_2), the preamble selection engine 702 may be configured to select a preamble code from the second subset (e.g., M255_3, M255_4). In some embodiments, the preamble selection engine 702 may be configured to select a different preamble code by applying a selection criteria to the auto- and cross-correlation sidelobe suppression ratios provided in the preamble code tables. For example, the preamble selection engine 702 may be configured to select a different preamble code which includes an autocorrelation sidelobe suppression ratio which is less than a certain threshold dB, and a corresponding cross-correlation sidelobe suppression ratio which is greater than a certain threshold dB. Continuing this example with reference to FIG. 8A-FIG. 8B, the preamble selection engine 702 may be configured to select a preamble code having an autocorrelation sidelobe suppression ratio which is less than 63 dB, and a cross-correlation sidelobe suppression ratio which is greater than 12 dB. In some embodiments, the selection criteria may be based on one (e.g., not both) of the sidelobe suppression ratios. For example, the preamble selection engine 702 may be configured to select a preamble code having an autocorrelation sidelobe suppression ratio which is less than 63 dB, or a cross-correlation sidelobe suppression ratio which is greater than 12 dB. Once the preamble selection engine 702 selects a new preamble code (e.g., and shares the new preamble code with the intended device recipient), the communication device 308 may be configured to incorporate the new preamble code in subsequent data transmissions 708 to the intended recipient device.

Referring now to FIG. 9A-FIG. 15B, and as noted above, different preamble code tables may be used according to different applications or use cases. For example, and as shown in FIG. 9A-FIG. 9B, some devices 302, 304 may use m-sequence preamble codes having a sequence length of 511. In this example, the devices 302, 304 may select preamble codes having an autocorrelation sidelobe suppression ratio of at least 54 dB (20*log 10(511)) and/or a cross-correlation sidelobe suppression ratio which is greater than 19 dB. In the example shown in FIG. 10A-FIG. 10B, some devices 302, 304 may use m-sequence preamble codes having a sequence length of 1023. In this example, the devices 302, 304 may select preamble codes having an autocorrelation sidelobe suppression ratio of at least 60 dB (20*log 10(1023)) and/or a cross-correlation sidelobe suppression ratio which is greater than 22 dB. In the example shown in FIG. 11A-FIG. 11B, some devices 302, 304 may use m-sequence preamble codes having a sequence length of 2047. In this example, the devices 302, 304 may select preamble codes having an autocorrelation sidelobe suppression ratio of at least 66 dB (20*log 10(2047)) and/or a cross-correlation sidelobe suppression ratio which is greater than 29 dB.

In the example shown in FIG. 12A-FIG. 12C, some devices 302, 304 may use algebraically constructed, determined, or derived preamble codes (shown in the respective tables) having a sequence length of 15. The preamble codes may be determined using an exhaustive search (e.g., algorithmically and/or artificially-intelligence based search). Such devices 302, 304 may select sequences grouped together and shown in either white or gray, as these sequences may have sidelobe suppression ratios known to satisfy a threshold criteria (e.g., autocorrelation sidelobe suppression ratios of at least 23 dB and cross-correlation sidelobe suppression ratios of at least 9.5 dB, as shown in FIG. 13). Similarly, in the example shown in FIG. 14A-FIG. 15B, some devices 302, 304 may use derived sequence preamble codes (e.g., shown in the respective tables) having a sequence length of 17 (for FIG. 14A-FIG. 14C) or 19 (for FIG. 15A-FIG. 15B). Such devices 302, 304 may select sequences grouped together and shown in either white or gray. While these sequences are provided, it is noted that similar sequences with equivalent properties (e.g., autocorrelation and/or cross-correlation properties) by performing a circular shift (e.g., shifting the sequence by N-number of elements or characters), by multiplying the sequence by a scalar (e.g., 1, −1, i, −I, etc.).

In each of these examples, the devices 302, 304 may be configured to select and/or switch between preamble codes based on or according to sidelobe suppression ratios reflected in or otherwise included in the preamble code tables as described herein. The devices 302, 304 may be configured to share their respective preamble codes with an intended recipient, and incorporate or otherwise provide the selected preamble code into data transmissions sent to the intended recipient. The intended recipient device may be configured to receive the data transmission, extract or identify the preamble code from the data transmission, and determine that it is the intended recipient of the data transmission responsive to the preamble code matching a shared preamble code.

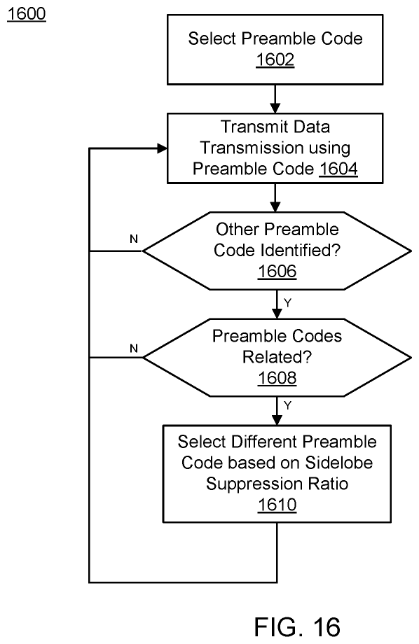

Referring now to FIG. 16, depicted is a flowchart showing a method 1600 for selecting preamble codes for UWB transmissions, according to an example implementation of the present disclosure. The method 1600 may be performed by the devices 302, 304 described above with reference to FIG. 1A-FIG. 7, and using one or more of the tables described above with reference to FIG. 8A-FIG. 15B. As a brief overview, at step 1602, a device selects a preamble code. At step 1604, the device transmits a data transmission using the preamble code. At step 1606, the device determines whether another preamble code has been identified. At step 1608, the device determines whether the preamble codes are related. At step 1610, the device selects a different preamble code based on a sidelobe suppression ratio.

At step 1602, a device selects a preamble code. In some embodiments, the device selects a first preamble code of a plurality of preamble codes for a data transmission sent via one or more ultra-wideband (UWB) antenna(s) to a second device. The plurality of preamble codes (e.g., from which the device selects the preamble code) may have a sidelobe suppression ratio of at least 12 dB with respect to another one of the plurality of preamble codes. In some embodiments, the device may select the preamble code at step 1602 responsive to or as part of negotiating or establishing a session with the second device. For example, the device may determine to establish a connection, channel, or session with the second device (e.g., responsive to the devices being in range of each other, responsive to a user input to a respective device that triggers establishing the session, etc.). As part of establishing the session, the devices may select respective preamble codes to use for data transmissions sent between the devices. The preamble codes may be known to the respective devices and used to determine that a respective device is an intended recipient of a particular data transmission. For example, upon receiving a given data transmission, a device may extract the preamble code from the data transmission and determine whether the preamble code matches any particular preamble code previously shared by another device as part of negotiating or establishing the session. Responsive to the preamble code matching a known preamble code, the device may parse, analyze, or inspect the body of the data transmission. On the other hand, where the preamble code does not match a known preamble code, the device may discard, ignore, or otherwise disregard the data transmission.

In some embodiments, each of the preamble codes may have the same sequence length. For example, the preamble codes may include m-sequence preamble codes (e.g., as described above with respect to FIG. 8A-FIG. 11B). As another example, the preamble codes may include derived preamble codes (e.g., as described above with respect to FIG. 12A-FIG. 15B). However, each of the preamble codes from which a particular device selects a preamble code may be the same sequence length. For instance, the sequence lengths may be or include 15, 17, 19, 63, 255, 511, 1023, or 2047 characters. The characters may include two or four characters (e.g., depending on the particular preamble code type). For example, the characters may include {0, 1, −1, i, −i}, where i is equal to the square root of (−1). The m-sequence preamble codes may include {0, 1, −1} characters. In some embodiments, the m-sequence preamble codes may include {1, −1} characters. In some embodiments, the derived preamble codes may include {1, −1, i, −i} characters. In some embodiments, the preamble codes may be shifted by one or more characters (e.g., to shift each of the characters within the preamble code by one or more characters, where the first is now the second character, the second is now the third character and so forth, until the last character is now the first character, to provide one example).

In some embodiments, some of the preamble codes may be grouped into subsets or groups (e.g., to assign to groups of devices operating in different and/or partially-overlapping spaces). For example, each of a group of preamble codes having the same sequence length may be grouped into a first plurality or subset of preamble codes and a second plurality or subset of preamble codes. The first and second subsets may be distinct from one another (e.g., such that preamble codes of the first subset are not included in the preamble codes of the second subset). Additionally, at least one preamble code from a given subset may have a sidelobe suppression ratio of at least a threshold dB (e.g., 12 dB for sequence length of 255, for instance) with respect to another preamble code of the subset. Such implementations may provide for more efficient selection of preamble codes which satisfy a selection criteria based on sidelobe suppression ratios, rather than trial-and-error or guess-and-check approaches that may be used in other systems and methods.

At step 1604, the device transmits a data transmission using the preamble code. In some embodiments, the device may transmit the data transmission the data transmission including the first preamble code (e.g., selected at step 1602) via the UWB antenna(s) to the second device. The device may transmit the data transmission responsive to the device selecting the preamble code. In some embodiments, the device may transmit the data transmission including the preamble code responsive to receiving an acknowledgement from the second device of the selected preamble code. The data transmission may include the preamble code and a body including the data for transmission to the second device. The device may transmit the data transmission responsive to receiving the data to include in the body and responsive to selecting the preamble code.

At step 1606, the device determines whether another preamble code has been identified. In some embodiments, the device may receive another data transmission from a third device. The data transmission may be sent by or originate from a third device separate from the first and second device. The third device may be transmitting the data transmission to a different device other than the first or second device. The device may detect, intercept, or receive the data transmission from the third device. The device may extract or identify the preamble code from the data transmission. The device may identify the preamble code from the data transmission without analyzing or inspecting the body of the data from the transmission. The device may identify the preamble code to determine whether the device is the intended recipient of the data transmission. The device may determine that the device is not the intended recipient responsive to the preamble code not matching a known preamble code. Where the device does not identify additional preamble codes from data transmissions, the method 1600 may proceed back to step 1604, where the device generates subsequent data transmission(s) using the preamble code selected at step 1602. However, where the device does identify another preamble code, the method 1600 may proceed to step 1608.

At step 1608, the device determines whether the preamble codes are related. More specifically, the device may determine whether the preamble code selected at step 1602 is related to the preamble code identified at step 1606. The device may determine that the preamble codes are related responsive to the preamble codes matching and/or a determination of whether the preamble codes below to a same group or different groups (e.g., of the same codelength). In other words, the device may determine that another device in the environment is using the preamble code selected at step 1602, or is using a preamble code related via a same group/subset or in a counterpart group/subset (e.g., of the same code length). In some embodiments, the device may determine that the preamble codes are related responsive to the preamble code identified at step 1606 is in the same grouping or subset of preamble codes from which the preamble code selected at step 1602 is included. Where the device determines that the preamble codes are related, the method 1600 may proceed to step 1610. However, where the device determines that the preamble codes are not related, the method 1600 may proceed back to step 1604.

At step 1610, the device selects a different preamble code (e.g., of the same group or a different group) based on a sidelobe suppression ratio. In some embodiments, the device may select the different preamble code for subsequent data transmissions. The device may select the different preamble code responsive to identifying another preamble code being used in the environment by a different device and responsive to the preamble code being related to (e.g., the same as and/or grouped with) the preamble code previously selected and/or used by the device.

In some embodiments, responsive to determining to select a different preamble code, the device may identify a grouping, plurality, or subset of preamble codes. The device may identify the subset of preamble codes from which to select the different preamble code. The device may identify the subset based on the subset not including/having the preamble code selected at step 1602 and/or identified at step 1606, and/or based on a distance of the other device from the present device. The device may identify the subset of preamble codes based on at least one of the preamble codes having a sidelobe suppression ratio (e.g., autocorrelation and/or cross-correlation sidelobe suppression ratio) which satisfies a selection criteria from another preamble code of the subset. For instance, the device may identify the subset of preamble codes based on at least one preamble code having a sidelobe suppression ratio of at least 12 dB with respect to another preamble code of the subset. The device may select the different preamble code from the subset for the subsequent data transmissions. The device may share the selected preamble code (e.g., at step 1610) with the second device such that, upon the second device receiving subsequent transmissions, the second device may determine (e.g., using the preamble code) that the second device is the intended recipient of the subsequent transmissions.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
selecting, by a first device, a first preamble code of a plurality of preamble codes for a data transmission sent via at least one ultra-wideband (UWB) antenna to a second device, each of the plurality of preamble codes having a sidelobe suppression ratio of at least 12 dB with respect to another one of the plurality of preamble codes; and
transmitting, by the first device, the data transmission including the first preamble code via the UWB antenna to the second device.

2. The method of claim 1, further comprising:
determining, by the first device, that a third device in an environment of the first device and second device is using the first preamble code; and
selecting, by the first device, a second preamble code of the plurality of preamble codes, for a subsequent data transmission.

3. The method of claim 2, wherein all of the plurality of preamble codes have a same sequence length.

4. The method of claim 3, wherein a second plurality of preamble codes having the same sequence length is defined, each of the second plurality of preamble codes being (i) distinct from the plurality of preamble codes and (ii) having a sidelobe suppression ratio of at least 12 dB with respect to another one of the second plurality of preamble codes.

5. The method of claim 1, wherein the plurality of preamble codes comprise an alphabet of at least one of two characters or four characters.

6. The method of claim 5, wherein the two characters or four characters include one or more characters from {0, 1, −1, i, −i}.

7. The method of claim 1, wherein the plurality of preamble codes comprises m-sequence preamble codes.

8. The method of claim 1, wherein the plurality of preamble codes comprises preamble codes having a sequence length of 15, 17, 19, 63, 255, 511, 1023, or 2047.

9. The method of claim 1, comprising:
determining, by the first device, that a third device in an environment of the first device and the second device is using a preamble code of the plurality of preamble codes;
identifying, by the first device, a second plurality of preamble codes; and
selecting, by the first device, a second preamble code of the second plurality of preamble codes for a subsequent data transmission.

10. The method of claim 9, wherein the plurality of preamble codes has a same number of preamble codes as the second plurality of preamble codes.

11. A first device, comprising:
at least one ultra-wideband (UWB) antennas; and
at least one processor configured to:
select a first preamble code of a plurality of preamble codes for a data transmission sent via at least one ultra-wideband (UWB) antenna to a second device, each of the plurality of preamble codes having a sidelobe suppression ratio of at least 12 dB with respect to another one of the plurality of preamble codes; and
transmit, via the at least one UWB antenna, the data transmission including the first preamble code via the UWB antenna to the second device.

12. The first device of claim 11, wherein the at least one processor is configured to:
determine that a third device in an environment of the first device and second device is using the first preamble code; and
select a second preamble code of the plurality of preamble codes, for a subsequent data transmission.

13. The first device of claim 12, wherein all of the plurality of preamble codes have a same sequence length.

14. The first device of claim 13, wherein a second plurality of preamble codes having the same sequence length is defined, each of the second plurality of preamble codes being (i) distinct from the plurality of preamble codes and (ii) having a sidelobe suppression ratio of at least 12 dB with respect to another one of the second plurality of preamble codes.

15. The first device of claim 11, wherein the plurality of preamble codes comprise an alphabet of at least one of two characters or four characters.

16. The first device of claim 15, wherein the two characters or four characters include one or more characters from {0, 1, −1, i, −i}.

17. The first device of claim 11, wherein the plurality of preamble codes comprises m-sequence preamble codes.

18. The first device of claim 11, wherein the plurality of preamble codes comprises preamble codes having a sequence length of 15, 17, 19, 63, 255, 511, 1023, or 2047.

19. The first device of claim 11, wherein the at least one processor is configured to:
determine that a third device in an environment of the first device and the second device is using a preamble code of the plurality of preamble codes;
identify a second plurality of preamble codes; and
select a second preamble code of the second plurality of preamble codes for a subsequent data transmission.

20. The first device of claim 19, wherein the plurality of preamble codes has a same number of preamble codes as the second plurality of preamble codes.
